(19) United States
(12) Patent Application Publication
(10) Pub. No.: US 2021/0287347 A1
(43) Pub. Date: Sep. 16, 2021

(54) IMAGE CONVERSION APPARATUS, CONTROL METHOD FOR IMAGE CONVERSION APPARATUS, AND STORAGE MEDIUM

(71) Applicant: CANON KABUSHIKI KAISHA, Tokyo (JP)

(72) Inventor: Koji Mito, Kanagawa (JP)

(21) Appl. No.: 17/196,515

(22) Filed: Mar. 9, 2021

(30) Foreign Application Priority Data
Mar. 10, 2020 (JP) 2020-040803

(51) Int. Cl. G06T 5/00

(52) U.S. Cl. CPC G06T 5/008; G06T 2207/20208; G06T 2207/10024

(57) ABSTRACT

An image conversion apparatus according to an embodiment of the present invention includes an image input unit configured to acquire image data, a correction unit configured to correct the image data by compressing a gradation exceeding a first threshold value with a predetermined correction strength, and a combining unit configured to combine a warning image which differs according to the predetermined correction strength with an area having a gradation exceeding a second threshold value in the image data.

### BACKGROUND OF THE INVENTION

### Field of the Invention

The present invention relates to an image conversion apparatus, a control method for an image conversion apparatus, and a storage medium.

### Description of the Related Art

The dynamic range of an imaging apparatus is increased in response to an improvement in the sensitivity of a photo acceptance unit. On the other hand, the dynamic range of an image signal output from the imaging apparatus is limited by a transmission method. A high dynamic range (HDR) transmission method of the image signal includes an original Log method of a camera manufacturer, and Recommendation ITU-R BT.2100 (BT.2100) developed by the International Telecommunication Union-Radiocommunication Sector (ITU-R). Further, BT.2100 is divided into a perceptual quantization (PQ) method and a hybrid log gamma (HLG) method. These HDR transmission methods have different dynamic ranges.

Incidentally, the dynamic range of the imaging apparatus changes due to exposure adjustment of a diaphragm or sensitivity, and hence there are cases where the dynamic range thereof exceeds the dynamic range of the image signal based on the above transmission method. In the case where an input dynamic range (the dynamic range of the imaging apparatus) exceeds an output dynamic range (the dynamic range of the image signal which is to be output), a gradation which is not less than the output dynamic range is saturated and becomes invisible. In this case, it is possible to identify an area in which the gradation is saturated (saturated area) by using a specific color or replacement by a pattern image.

As a technique for identifying the saturated area, Japanese Patent Application Publication No. 2006-165716 discloses a technique for allowing a relationship between an exposure adjustment value and the saturated area to be determined by color-coding the saturated areas of a plurality of the exposure adjustment values and displaying the saturated areas at the same time.

In addition, Japanese Patent Application Publication No. 2014-167609 discloses a technique for allowing the gradation of the saturated area to be determined by color-coding and the saturated areas according to a gradation value and displaying the saturated areas.

By color-coding and displaying the saturated area, it becomes possible to determine the saturated area. However, in the case where correction is performed such that the input dynamic range falls within the output dynamic range, it is difficult to determine a corrected area and a correction strength in the saturated area.

### SUMMARY OF THE INVENTION

The present invention provides a technique for allowing a corrected area and a correction strength of knee correction to be easily determined.

An image conversion apparatus according to an embodiment of the present invention includes an image input unit configured to acquire image data, a correction unit configured to correct the image data by compressing a gradation exceeding a first threshold value with a predetermined correction strength, and a combining unit configured to combine a warning image which differs according to the predetermined correction strength with an area having a gradation exceeding a second threshold value in the image data.

Further features of the present invention will become apparent from the following description of exemplary embodiments with reference to the attached drawings.

### BRIEF DESCRIPTION OF THE DRAWINGS

FIG. 1 is an example of the configuration of an image conversion apparatus according to Embodiment 1;

FIG. 2 is a view illustratively showing a warning image;

FIG. 3 is a view showing a first example of zebra color conversion table;

FIG. 4 is a flowchart illustratively showing parameter setting processing according to Embodiment 1;

FIGS. 5A to 5C are views showing a first example of input-output conversion characteristics to which knee correction is applied;

FIGS. 6A to 6C are views showing a second example of input-output conversion characteristics to which the knee correction is not applied;

FIG. 7 is a view showing a second example of the zebra color conversion table;

FIG. 8 is a flowchart illustratively showing zebra color conversion table generation processing:

FIG. 9 is a flowchart illustratively showing warning image combining processing;

FIGS. 10A to 10C are views illustratively showing image data with which a warning image is combined:

FIGS. 11A and 11B are views showing third and fourth examples of the zebra color conversion table:

FIGS. 12A to 12C are views showing a third example of input-output conversion characteristics to which the knee correction is partially applied:

FIG. 13 is an example of the configuration of each of an image correction apparatus and an image conversion apparatus according to Embodiment 2:

FIG. 14 is a flowchart of parameter setting processing of the image correction apparatus according to Embodiment 2; and

FIG. 15 is a flowchart of parameter setting processing of the image conversion apparatus according to Embodiment 2.

### DESCRIPTION OF THE EMBODIMENTS

### Embodiment 1

Hereinbelow, embodiments of the present invention will be described by using the drawings. In the case where the dynamic range (input dynamic range) of an imaging apparatus exceeds an output dynamic range, it is possible to cause the input dynamic range to fall within the output dynamic range by knee correction which compresses a signal which is not less than a predetermined gradation (knee point).

However, by performing the knee correction, resolution in a gradation which is not less than the knee point is reduced in proportion to a correction strength. Accordingly, in a natural image, it is difficult to determine a corrected area corrected by the knee correction and the correction strength. In addition, there is a possibility of the occurrence of loss of gradation of a subject which is not intended by a user.

To cope with this, an image conversion apparatus according to the present embodiment allows the corrected area and the correction strength in a saturated area to be easily determined by changing a warning image which is displayed in the corrected area of the knee correction according to the correction strength.

Apparatus Configuration

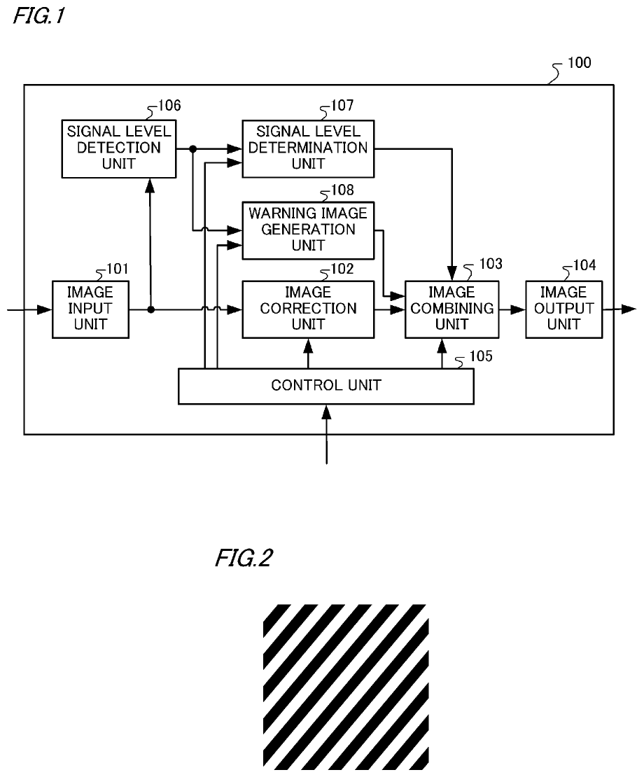

FIG. 1 is a block diagram showing functional blocks of an image conversion apparatus 100. The image conversion apparatus 100 includes an image input unit 101, an image correction unit 102, an image combining unit 103, an image output unit 104, a control unit 105, a signal level detection unit 106, a signal level determination unit 107, and a warning image generation unit 108. The image conversion apparatus 100 may be a computer or the like which operates as an imaging apparatus or a display apparatus, or may also be a computer or the like which operates image editing software.

The image input unit 101 is an acquisition unit configured to acquire image data from the outside. In the case where the image conversion apparatus 100 is the imaging apparatus, the image input unit 101 has an image sensor, and acquires image data obtained by performing color or gradation correction processing on an electrical signal output by the image sensor. In the case where the image conversion apparatus 100 is the display apparatus, the image input unit 101 has an input interface such as a serial digital interface (SDI), and acquires image data from the input interface. In the case where the image conversion apparatus 100 is the computer which operates the image editing software, the image input unit 101 reads an image file retained in a storage apparatus to acquire image data.

The image correction unit 102 performs correction processing on the image data acquired in the image input unit 101. Specifically, the image correction unit 102 executes conversion processing which uses a one-dimensional lookup table (1D-LUT) defined for each set of RGB values of the image data. Note that the correction processing by the image correction unit 102 is not limited to the conversion processing using the 1D-LUT, and it is possible to use another image correction processing such as, e.g., a three-dimensional lookup table (3D-LUT), gain adjustment, offset adjustment, or matrix conversion.

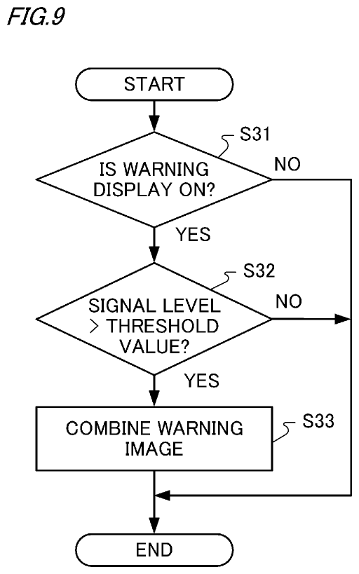

The image combining unit 103 combines a warning image generated in the warning image generation unit 108 described later with the image data corrected in the image correction unit 102 according to a determination result of the signal level determination unit 107 described later. Warning image combining processing of the image combining unit 103 will be described later with reference to a flowchart in FIG. 9.

The image output unit 104 outputs the image data processed in the image combining unit 103 to the outside. Specifically, the image output unit 104 has an output interface such as, e.g., an SDI, and outputs the image data from the output interface. In addition, in the case where the image output unit 104 has a display panel such as a liquid crystal panel or a driver of the display panel, the image output unit 104 displays image data subjected to correction processing based on the color gamut or gradation characteristics of the display panel in the display panel.

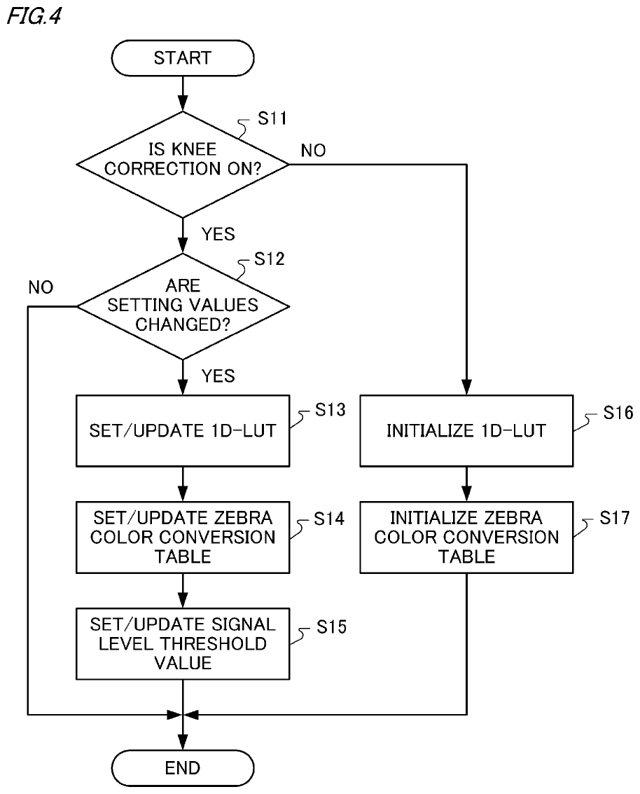

The control unit 105 sets parameters corresponding to the knee correction in individual blocks (functional units) based on a user operation. Specifically, the control unit 105 sets the 1D-LUT in the image correction unit 102, sets a threshold value of a signal level in the signal level determination unit 107, and sets a conversion table in the warning image generation unit 108. The detail of parameter setting processing based on the knee correction in the control unit 105 will be described later with reference to a flowchart in FIG. 4. Further, the control unit 105 sets a parameter indicating that a warning display is valid/invalid in the image combining unit 103 based on the user operation.

The signal level detection unit 106 converts RGB values of the image data and detects the signal level. The signal level detected in the signal level detection unit 106 is specifically the maximum value of the RGB values of the image data. Note that the signal level detected in the signal level detection unit 106 is not limited to the maximum value of the RGB values of the image data. For example, the signal level detection unit 106 may convert the RGB values of the image data to YCbCr values, and may detect the Y value as the signal level.

The signal level determination unit 107 determines the signal level by comparing the signal level detected in the signal level detection unit 106 with the threshold value set by the control unit 105. The determination result is output to the image combining unit 103.

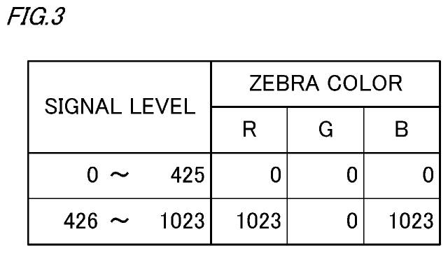

The warning image generation unit 108 generates the warning image, and outputs the warning image to the image combining unit 103. Herein, the warning image will be described with reference to FIGS. 2 and 3. The warning image is, e.g., a zebra pattern image shown in FIG. 2. The warning image generation unit 108 changes a display color of a zebra pattern (a black portion in FIG. 2) according to the signal level detected in the signal level detection unit 106.

The display color of the zebra pattern is determined by using a conversion table (hereinafter referred to as a zebra color conversion table) which converts the signal level to the RGB values. The zebra color conversion table is set in the warning image generation unit 108 by the control unit 105. Herein, the zebra color conversion table will be described with reference to FIG. 3. In the case where the zebra color conversion table in FIG. 3 is used, the warning image generation unit 108 generates a black zebra pattern image in the case where the signal level is 0 to 425, and generates a magenta zebra pattern image in the case where the signal level is 426 to 1023. Note that the pattern of the warning image is not limited to the pattern of the zebra pattern image, and the warning image may be another image such as a colored image colored in one color. In addition, the warning image generation unit 108 can change the display color according to the signal level, but the warning image generation unit 108 is not limited thereto. For example, the warning image generation unit 108 may change an interval, thickness, or slope of a stripe of the zebra pattern according to the signal level.

Parameter Setting Processing Herein, the parameter setting processing based on the knee correction by the control unit 105 will be described with reference to FIG. 4. FIG. 4 is a flowchart illustratively showing the parameter setting processing according to Embodiment 1.

In S11, the control unit 105 determines whether a knee correction function is turned ON or OFF by the user operation. In the case where the knee correction function is ON, the processing proceeds to S12. In the case where the knee correction function is OFF, the processing proceeds to initialization processing in S16 and S17.

In S12, the control unit 105 determines whether or not setting values of the knee correction are changed by the user operation. In the case where the setting values of the knee correction are changed, the processing proceeds to S13 to S15, and each parameter is set or updated. In the case where the setting values of the knee correction are not changed, the parameter setting processing shown in FIG. 4 is ended.

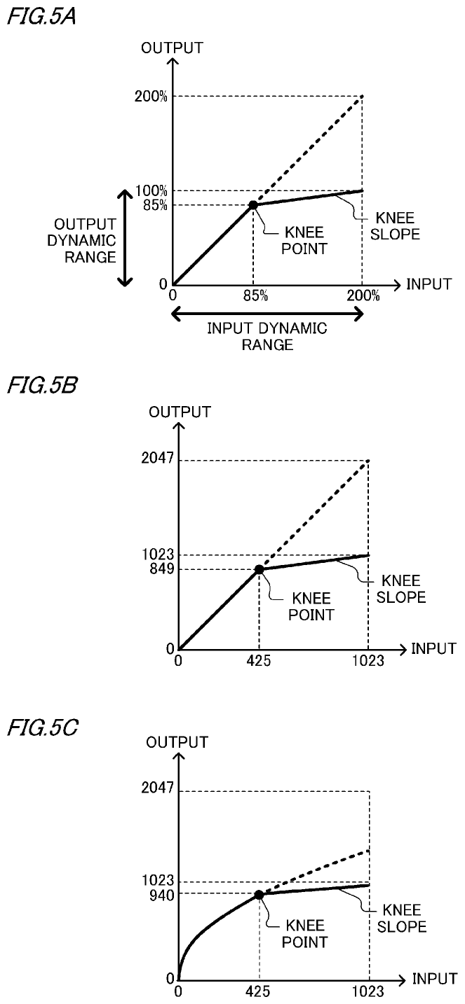

Herein, the setting values of the knee correction and generation of the 1D-LUT will be described with reference to FIGS. 5A to 5C. FIGS. 5A to 5C are views showing a first example of input-output conversion characteristics to which the knee correction is applied. Examples of the setting values of the knee correction include a knee point and a knee slope. The knee point (first threshold value) denotes a start point of the knee correction. The knee slope denotes a compression degree (correction strength) of the knee correction.

In an example in FIG. 5A, a signal having a signal level of not less than 85% is compressed by 0.13 times (≈(100%−85%)/(200%−85%)) by the knee correction. That is, in FIG. 5A, the knee point is the signal level of 85% and the knee slope is 0.13. Note that FIG. 5B is a graph in which each of an input dynamic range and an output dynamic range in FIG. 5A is normalized to 10-bit gradation (0 to 1023). In FIG. 5B, the knee point is 425 which is the signal level of an input signal.

In S13, the control unit 105 generates the 1D-LUT in which the knee correction is reflected based on the setting values of the knee correction changed in S12, and sets the generated 1D-LUT in the image correction unit 102. FIG. 5B is the graph in which each of the input dynamic range and the output dynamic range in FIG. 5A is normalized to the 10-bit gradation (0 to 1023), and FIG. 5C is a graph in which an output value in FIG. 5B is corrected by the ½ power of gamma. In the case where an image signal is output by using the correction by the ½ power of gamma in the image conversion apparatus 100, in S13, the control unit 105 sets the 1D-LUT corresponding to characteristics in FIG. 5C in the image correction unit 102. In the case where the image correction unit 102 already has the 1D-LUT, the existing 1D-LUT is replaced with the 1D-LUT generated by the control unit 105.

In S14, the control unit 105 generates the zebra color conversion table for converting the signal level to the display color of the zebra pattern based on the knee point and the knee slope changed in S12, and sets the generated zebra color conversion table in the warning image generation unit 108. The detail of zebra color conversion table generation processing will be described later with reference to a flowchart in FIG. 8. In the case where the warning image generation unit 108 already has the zebra color conversion table, the existing zebra color conversion table is replaced with the zebra color conversion table generated by the control unit 105.

In S15, the control unit 105 sets the knee point changed in S12 as a signal level threshold value in the signal level determination unit 107. In the example in FIG. 5B, the knee point is 425 which is the signal level of the input signal, and hence 425 is set in the signal level determination unit 107 as the signal level threshold value. In the case where the signal level threshold value is already set in the signal level determination unit 107, the existing signal level threshold value is replaced with the knee point changed in S12. Note that the processing in S15 can be omitted. For example, the existing signal level threshold value may be changed to a threshold value other than the knee point by the user operation.

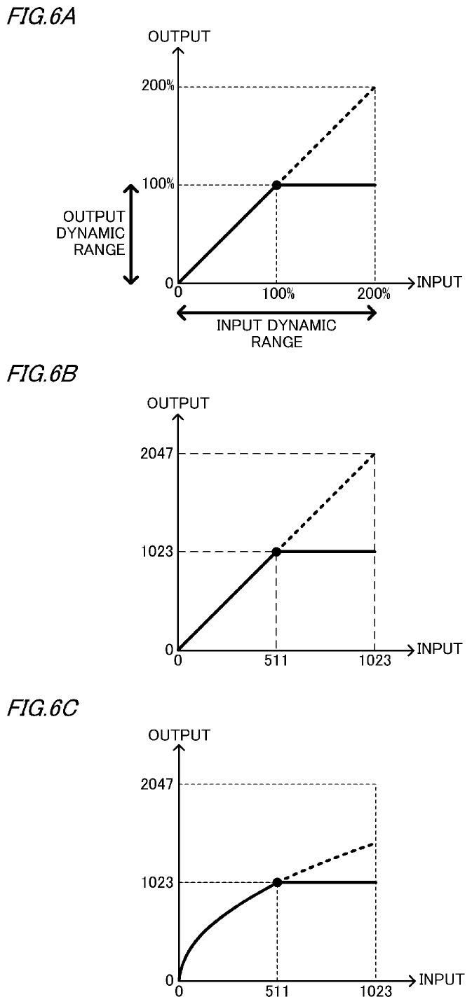

In S16, the control unit 105 initializes the 1D-LUT which is to be set in the image correction unit 102. Herein, the initialization of the 1D-LUT will be described with reference to FIGS. 6A to 6C. FIGS. 6A to 6C are views showing a second example (example of the initialization) of input-output conversion characteristics to which the knee correction is not applied. FIG. 6A is a graph in which the input-output conversion characteristics are luminance linear characteristics in the input dynamic range of 0 to 100%, and the input-output conversion characteristics are clipped to 100% in the input dynamic range of 101 to 200%. FIG. 6B is a graph in which each of the input dynamic range and the output dynamic range in FIG. 6A is normalized to the 10-bit gradation (0 to 1023). FIG. 6C is a graph in which an output value in FIG. 6B is corrected by the ½ power of gamma. In the 1D-LUT initialization processing in S16, the 1D-LUT set in the image correction unit 102 is the 1D-LUT corresponding to conversion characteristics shown in FIG. 6C.

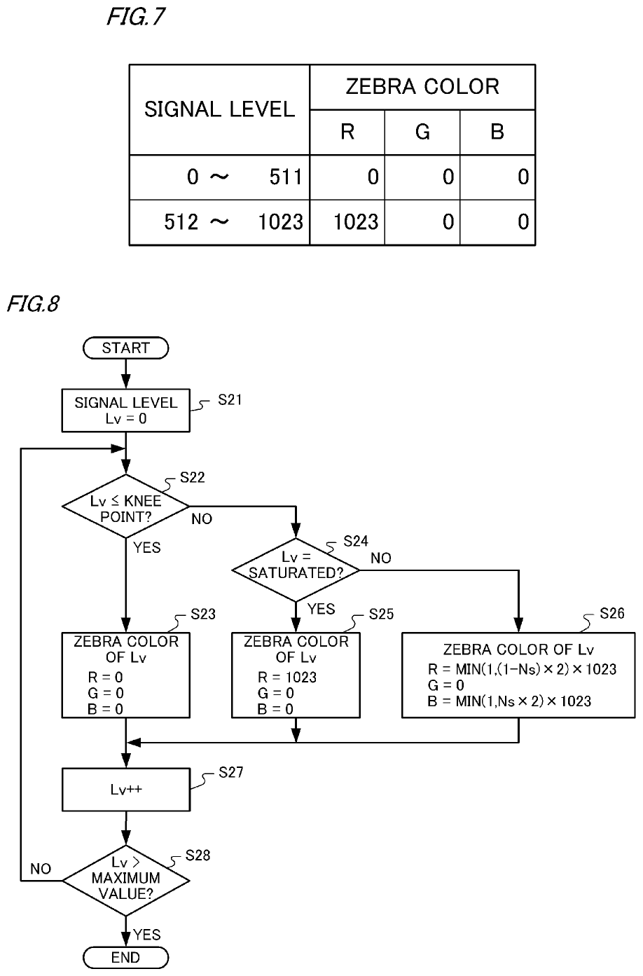

In S17, the control unit 105 initializes the zebra color conversion table which is to be set in the warning image generation unit 108. Herein, the initialization of the zebra color conversion table will be described with reference to FIG. 7. FIG. 7 is a view showing a second example (example of the initialization) of the zebra color conversion table. In the case where the initialized zebra color conversion table is used, the warning image generation unit 108 generates the black warning image when the signal level is 0 to 100% (0 to 511 in the 10-bit gradation), and generates the warning image having the zebra color converted to red when the signal level is 101 to 200% (512 to 1023 in the 10-bit gradation).

Zebra Color Conversion Table Generation Processing

Herein, with reference to FIG. 8, a description will be given of processing in which the control unit 105 generates the zebra color conversion table in S14 in FIG. 4. FIG. 8 is a flowchart illustratively showing the zebra color conversion table generation processing.

In S21, the control unit 105 sets 0 as a signal level Lv to thereby perform initialization. In S22, the control unit 105 determines whether or not the signal level Lv is not more than the knee point. In the case where the signal level Lv is not more than the knee point, the processing proceeds to S23. In the case where the signal level Lv is more than the knee point, the processing proceeds to S24.

In S23, the control unit 105 sets the display color of the zebra pattern to [R=0, G=0, B=0]. That is, in the case where the signal level Lv is not more than the knee point and the knee correction is not performed, the control unit 105 sets black as the output value of the zebra color conversion table.

In S24, the control unit 105 determines whether or not the signal level Lv is saturated. In the case where the signal level Lv is saturated, the processing proceeds to S25. In the case where the signal level Lv is not saturated, the processing proceeds to S26.

In S25, the control unit 105 sets the display color of the zebra pattern to [R=1023, G=0, B=0]. That is, in the case of the saturated signal level, the control unit 105 sets red as the output value of the zebra color conversion table.

In S26, the control unit 105 sets the display color of the zebra pattern to [R=0, G=0, B=1023], to [R=1023, G=0, B=1023], and to [R=1023, G=0, B=0]. That is, in the case of the signal level at which the knee correction is performed, the control unit 105 sets blue, magenta, and red as the output values of the zebra color conversion table.

The control unit 105 changes the output value set in the zebra color conversion table according to the knee slope, i.e., a compression ratio of the knee correction. Specifically, in the case where the knee slope is Ns (0.00 to 1.00), the RGB values of the output value of the zebra color conversion table are determined by the following Formula 1:

R=MIN(1,(1−Ns)×2)×1023

G=0

B=MIN(1,Ns×2)×1023 (Formula 1)

MIN ( ) in Formula 1 is a function for selecting a minimum value. By calculating the RGB values by using Formula 1, the display color of the zebra pattern changes from blue to magenta and from magenta to red as the compression ratio of the knee correction increases. Note that the RGB values of the output value of the zebra color conversion table are not limited to Formula 1, and may be calculated according to the correction strength such as the compression ratio of the knee correction.

In addition, as shown in the following Formula 2, the degree of change may be changed by performing gamma correction on the compression ratio of the knee correction. adjGamma in Formula 2 is an adjustment gamma.

R=MIN(1,(1−Ns^{adjGamma})×2)×1023

G=0

B=MIN(1,Ns^{adjGamma}×2)×1023 (Formula 2)

In S27, the control unit 105 continuously increments the value of the signal level Lv by 1. In S28, the control unit 105 determines whether or not the signal level Lv exceeds the maximum value in the image data. In the case where the signal level Lv exceeds the maximum value, the zebra color conversion table generation processing is ended. In the case where the signal level Lv does not exceed the maximum value, the processing returns to S22. The control unit 105 repeats the processing in S22 to S27, and sets the RGB values of the display color of the zebra pattern of each signal level in the zebra color conversion table.

Warning Image Combination Processing

Herein, the warning image combining processing by the image combining unit 103 will be described with reference to FIG. 9. FIG. 9 is a flowchart illustratively showing the warning image combining processing. The warning image combining processing is processing for combining the warning image with an area having the signal level of more than the threshold value (second threshold value) in the image data. The combining of the warning image includes processing for replacing the area having the signal level of more than the threshold value with the warning image.

In S31, the image combining unit 103 determines whether or not the warning display is valid (a warning display function is ON) based on an instruction from the control unit 105. In the case where the warning display is invalid, the combining of the warning image is not performed, and the processing is ended. In the case where the warning display is valid, the processing proceeds to S32.

In S32, the image combining unit 103 determines whether or not the signal level detected in the signal level detection unit 106 is more than the threshold value. The determination result of the signal level can be acquired from the signal level determination unit 107. In the case where the signal level is not more than the threshold value, the combining of the warning image is not performed, and the processing is ended. In the case where the signal level is more than the threshold value, the processing proceeds to S33.

In S33, the image combining unit 103 combines the warning image generated in the warning image generation unit 108 with the image data output from the image correction unit 102. In the case where an alpha blending factor (a value) is specified for the warning image, the warning image is combined according to the a value. In the case where the a value is not specified, the image data is replaced with the warning image.

### Specific Example of Warning Display

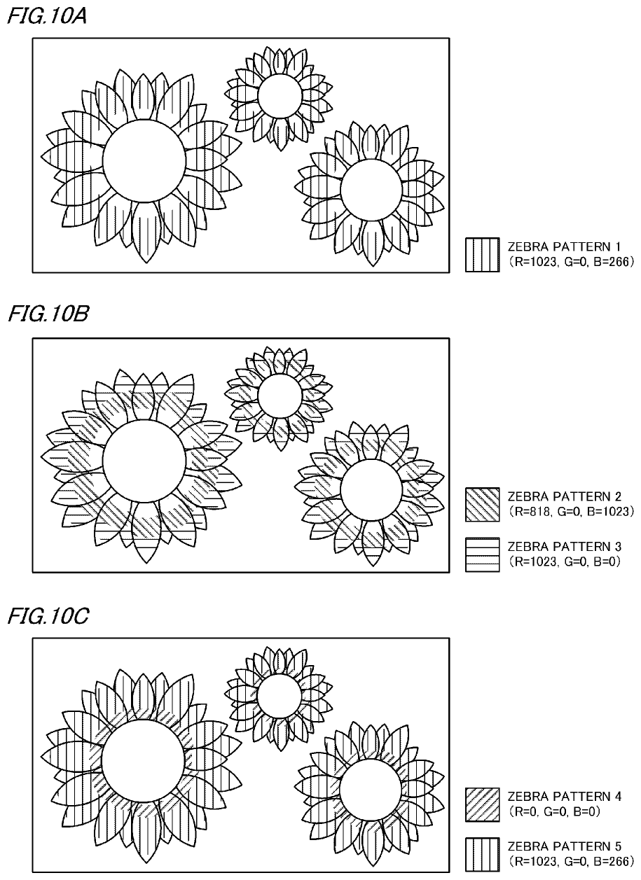

Herein, with reference to FIGS. 10A to 10C, the warning display based on the knee correction will be described by using specific examples. FIGS. 10A to 10C are views illustratively showing the image data with which the warning image is combined.

FIG. 10A is an example of the image data to which the knee correction in FIGS. 5A to 5C is applied. A zebra pattern 1 in FIG. 10A shows an area having the signal level of 86 to 200%. In the example in FIGS. 5A to 5C, the knee point is the signal level of 85%, and the knee slope (the compression ratio of the knee correction) is 0.13 (≈(100%−85%)/(200%−85%)). Accordingly, by substituting 0.13 for Ns in Formula 1, the display color of the zebra pattern 1 having the signal level of 86 to 200% (426 to 1023 in the 10-bit gradation) is calculated in the following manner by Formula 3:

R=MIN(1,(1−0.13)×2)×1023=1×1023=1023

G=0

B=MIN(1,0.13×2)×1023=0.26×1023=266 (Formula 3)

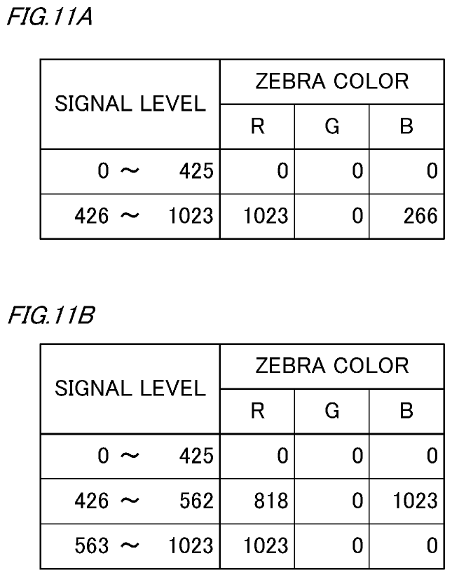

In this case, the control unit 105 generates the zebra color conversion table shown in FIG. 11A, and sets the zebra color conversion table in the warning image generation unit 108. FIG. 11A is a view showing a third example of the zebra color conversion table. In the zebra color conversion table shown in FIG. 11A, the output value of the signal level of 426 to 1023 is set to [R=1023, G=0, B=266].

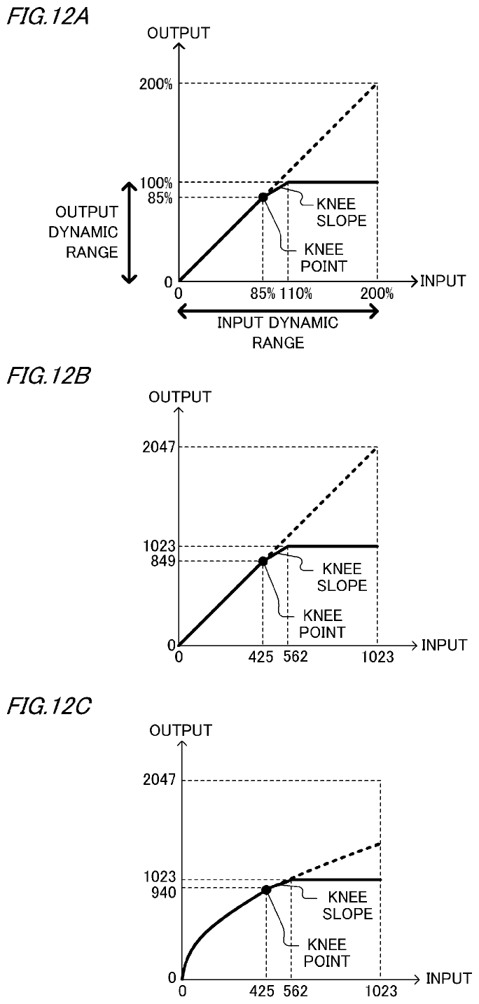

FIG. 10B is an example of the image data to which the knee correction in FIGS. 12A to 12C is applied. A zebra pattern 2 in FIG. 10B shows an area having the signal level of 86 to 110%, and a zebra pattern 3 shows an area having the signal level of 111 to 200%. In examples in FIGS. 12A to 12C, the knee point is the signal level of 85%, and the knee slope (the compression ratio of the knee correction) is 0.6 (≈(100%−85%)/(110%−85%)). Accordingly, by substituting 0.6 for Ns in Formula 1, the display color of the zebra pattern 2 having the signal level of 86 to 110% (426 to 562 in the 10-bit gradation) is calculated in the following manner by Formula 4:

R=MIN(1,(1−0.6)×2)×1023=0.8×1023=818

G=0

B=MIN(1,0.6×2)×1023=1×1023=1023 (Formula 4)

The signal level of 111 to 200% (563 to 1023 in the 10-bit gradation) corresponds to a saturated area, and hence the display color of the zebra pattern 3 is [R=1023, G=0, B=0] according to S25 in the zebra color conversion table generation processing in FIG. 8.

In this case, the control unit 105 generates the zebra color conversion table shown in FIG. 1I B, and sets the zebra color conversion table in the warning image generation unit 108. FIG. 11B is a view showing a fourth example of the zebra color conversion table. In the zebra color conversion table shown in FIG. 11B, the output value of the signal level of 426 to 562 is set to [R=818, G=0, B=1023], and the output value of the signal level of 563 to 1023 is set to [R=1023, G=0, B=0].

Note that, in S15 in the parameter setting processing in FIG. 4, the control unit 105 sets the knee point as the threshold value of the signal level, but a threshold value other than the knee point can also be set.

In the example in FIG. 10A, 85% corresponding to the knee point is set as the threshold value of the signal level, and hence the zebra pattern 1 is displayed in the area having the signal level of 86 to 200%. Unlike the example in FIG. 10A, FIG. 10C is an example of the image data in which the threshold value of the signal level is changed to 80%. A zebra pattern 4 shows an area having the signal level of 80 to 85%, and a zebra pattern 5 shows an area having the signal level of 86 to 200%. In the zebra pattern 5, the range of the signal level is the same as that of the zebra pattern 1 in FIG. 10A, and hence the zebra pattern 5 is displayed in the same display color. As shown in FIGS. 5A to 5C, the signal level of 80 to 85% is not more than the knee point.

Consequently, according to S23 in the zebra color conversion table generation processing in FIG. 8, the display color of the zebra pattern 4 is [R=0, G=0, B=0].

Operation and Effect of Embodiment 1

As described above, the image conversion apparatus 100 of Embodiment 1 can change the warning image displayed in the corrected area of the knee correction to a different warning image according to the correction strength of the knee correction. With this, it becomes possible for the user to intuitively determine the corrected area and the correction strength of the knee correction. For example, in the case where the knee correction is automatically applied, the user can determine whether or not an unintended area is corrected with an unintended strength in advance. In addition, also in the case where the knee correction is manually adjusted, the user can save the effort of determining the correction strength of the knee correction every time the knee correction is adjusted. Further, the saturated area is changed according to the correction strength of the knee correction, and hence it becomes possible for the user to adjust the knee correction while checking a balance between the correction strength and the saturated area.

Note that the example of the warning display for the knee correction has been described in Embodiment 1, but the present invention is not limited thereto. For example, it is also possible to apply the present invention to the warning display for gradation correction or color gamut correction.

### Embodiment 2

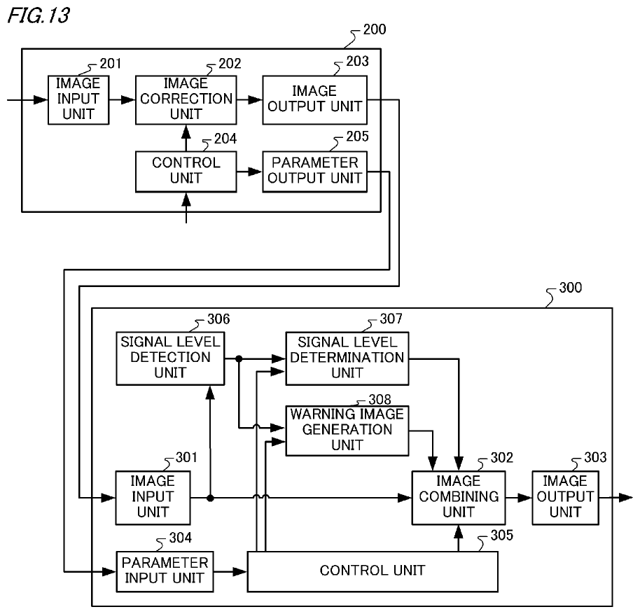

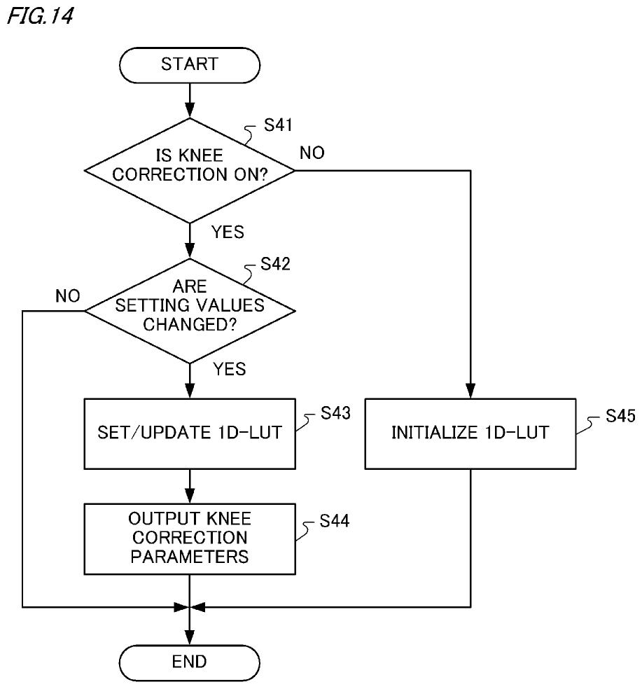

Hereinbelow, Embodiment 2 of the present invention will be described by using FIGS. 13 to 15. Embodiment 2 is an embodiment in which the image correction processing is executed by an external apparatus connected to the image conversion apparatus.

Apparatus Configuration

FIG. 13 is a block diagram showing functional blocks of an image correction apparatus 200 and an image conversion apparatus 300. The image correction apparatus 200 includes an image input unit 201, an image correction unit 202, an image output unit 203, a control unit 204, and a parameter output unit 205. The image conversion apparatus 300 includes an image input unit 301, an image combining unit 302, an image output unit 303, a parameter input unit 304, a control unit 305, a signal level detection unit 306, a signal level determination unit 307, and a warning image generation unit 308. The image correction apparatus 200 is an imaging apparatus such as, e.g., a camera, and the image conversion apparatus 300 is a display apparatus such as, e.g., a display.

The image input unit 201 of the image correction apparatus 200 is an acquisition unit configured to acquire image data from the outside. Specifically, the image input unit 201 has an image sensor, and acquires image data obtained by performing color or gradation correction processing on an electrical signal output by the image sensor.

Similarly to the image correction unit 102 of the image conversion apparatus 100 in FIG. 1, the image correction unit 202 of the image correction apparatus 200 performs correction processing including the knee correction on the image data acquired in the image input unit 201 based on image processing parameters set by the control unit 204 described later.

The image output unit 203 of the image correction apparatus 200 outputs the image data corrected in the image correction unit 202 to the outside. Specifically, the image output unit 203 has an output interface such as an SDI, and outputs the image data from the output interface.

The control unit 204 of the image correction apparatus 200 sets the image processing parameters including those related to the knee correction in the image correction unit 202 based on the user operation. Herein, the image processing parameter is the 1D-LUT but, as long as the image processing parameter is a parameter related to image processing, the image processing parameter is not limited to the 1D-LUT. The image processing parameter may also be a parameter of, e.g., gain adjustment, offset adjustment, or matrix conversion.

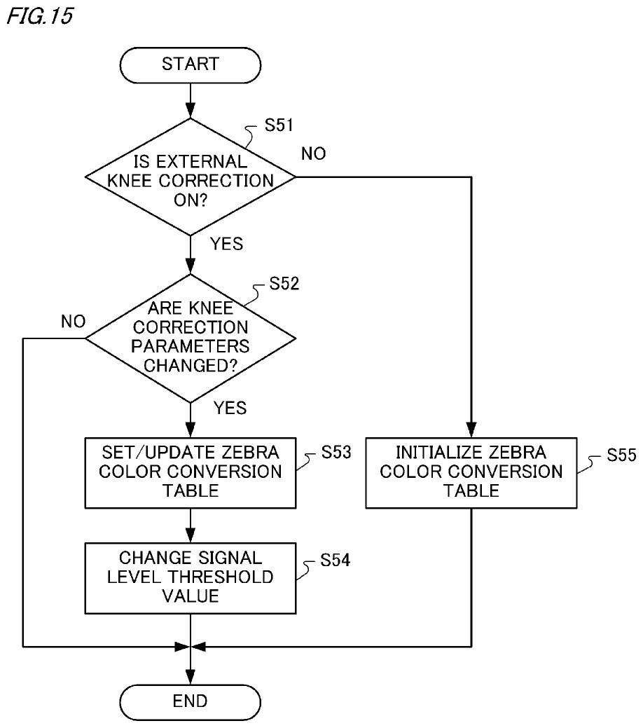

In addition, the control unit 204 outputs parameters related to the knee correction (hereinafter referred to as knee correction parameters) to the parameter output unit 205. The knee correction parameters include the knee point and the knee slope, but the knee correction parameters are not limited thereto, and the knee correction parameters may include the threshold value of the signal level and RGB values or the like set in the zebra color conversion table. The detail of parameter setting processing of the control unit 204 will be described later with reference to a flowchart in FIG. 14.

The parameter output unit 205 of the image correction apparatus 200 acquires the knee correction parameters from the control unit 204, and outputs the knee correction parameters to the parameter input unit 304 of the image conversion apparatus 300.

The image input unit 301 of the image conversion apparatus 300 is an acquisition unit configured to acquire image data from the outside. Specifically, the image input unit 301 has an input interface such as an SDI, and acquires image data from the input interface.

Similarly to the image combining unit 103 of the image conversion apparatus 100 in FIG. 1, the image combining unit 302 of the image conversion apparatus 300 combines the warning image generated in the warning image generation unit 308 described later with the image data acquired in the image input unit 301.

The image output unit 303 of the image conversion apparatus 300 outputs the image data processed in the image combining unit 302 to the outside. Specifically, the image output unit 303 has a display panel such as a liquid crystal panel or a driver of the display panel, and displays the image data subjected to correction processing based on the color gamut or gradation characteristics of the display panel in the display panel.

The parameter input unit 304 of the image conversion apparatus 300 acquires the knee correction parameters from the image correction apparatus 200. The control unit 305 of the image conversion apparatus 300 sets corresponding parameters in the signal level determination unit 307 and the warning image generation unit 308 based on the knee correction parameters acquired by the parameter input unit 304. The detail of parameter setting processing in the control unit 305 will be described with reference to a flowchart in FIG. 15. Further, the control unit 305 of the image conversion apparatus 300 sets a parameter indicating that the warning display is valid/invalid in the image combining unit 302 based on the user operation.

Similarly to the signal level detection unit 106 of the image conversion apparatus 100 in FIG. 1, the signal level detection unit 306 of the image conversion apparatus 300 converts the RGB values of the image data to detect the signal level.

Similarly to the signal level determination unit 107 of the image conversion apparatus 100 in FIG. 1, the signal level determination unit 307 of the image conversion apparatus 300 determines the signal level by comparing the signal level detected in the signal level detection unit 306 with a threshold value set by the control unit 305. The determination result is output to the image combining unit 302.

Similarly to the warning image generation unit 108 of the image conversion apparatus 100 in FIG. 1, the warning image generation unit 308 of the image conversion apparatus 300 generates the warning image, and outputs the warning image to the image combining unit 302.

Parameter Setting Processing of Image Correction Apparatus

The parameter setting processing by the control unit 204 of the image correction apparatus 200 will be described with reference to FIG. 14. FIG. 14 is a flowchart illustratively showing the parameter setting processing of the image correction apparatus according to Embodiment 2.

In S41, similarly to S11 in the parameter setting processing in FIG. 4, the control unit 204 determines whether the knee correction function is turned ON or OFF by the user operation. In the case where the knee correction function is ON, the processing proceeds to S42. In the case where the knee correction function is OFF, the processing proceeds to initialization processing in S45.

In S42, similarly to S12 in FIG. 4, the control unit 204 determines whether or not the setting values of the knee correction are changed by the user operation. In the case where the setting values of the knee correction are changed, the processing proceeds to S43 to S44, and each parameter is set or updated. In the case where the setting values of the knee correction are not changed, the parameter setting processing of the image correction apparatus shown in FIG. 14 is ended.

In S43, similarly to S13 in FIG. 4, the control unit 204 generates the 1D-LUT in which the knee correction is reflected based on the setting values of the knee correction, and sets the generated 1D-LUT in the image correction unit 202.

In S44, the control unit 204 outputs the knee correction parameters used in the generation of the 1D-LUT in S43 to the parameter output unit 205. Herein, the knee correction parameters are parameters related to the knee correction such as, e.g., the knee point, the knee slope, and the parameter indicating that the knee correction function is ON/OFF.

In S45, similarly to S16 in FIG. 4, the control unit 204 initializes the 1D-LUT which is to be set in the image correction unit 202.

Parameter Setting Processing of Image Conversion Apparatus The parameter setting processing by the control unit 305 of the image conversion apparatus 300 will be described with reference to FIG. 15. FIG. 15 is a flowchart illustratively showing the parameter setting processing of the image conversion apparatus according to Embodiment 2.

In S51, the control unit 305 determines whether the knee correction function of the image correction apparatus 200 which is an external apparatus is ON or OFF. Specifically, the control unit 305 acquires the knee correction parameters from the image correction apparatus 200 via the parameter input unit 304. The control unit 305 can determine whether the knee correction function is ON or OFF based on the parameter which is included in the knee correction parameters and indicates that the knee correction function is ON/OFF. In the case where the knee correction function is ON, the processing proceeds to S52. In the case where the knee correction function is OFF, the processing proceeds to initialization processing in S55.

In S52, the control unit 305 determines whether or not the knee correction parameters are changed. Specifically, the control unit 305 determines whether or not the knee point and the knee slope included in the knee correction parameters acquired from the image correction apparatus 200 are changed. For example, the control unit 305 can determine whether or not the knee correction parameters are changed by recording the knee correction parameters acquired from the image correction apparatus 200 in a storage unit such as an auxiliary storage apparatus in the image conversion apparatus 300 and comparing the recorded knee correction parameters with previously recorded knee correction parameters.

In the case where the knee correction parameters are changed, the processing proceeds to S53 to S54, and each parameter is set or updated. In the case where the knee correction parameters are not changed, the parameter setting processing of the image conversion apparatus shown in FIG. 15 is ended. Note that, in the following processing, a description will be made on the assumption that the knee correction parameters are the knee point and the knee slope.

In S53, similarly to S14 in FIG. 4, the control unit 305 generates the zebra color conversion table based on the knee point and the knee slope, and sets the generated zebra color conversion table in the warning image generation unit 108. Note that the knee point and the knee slope are included in the knee correction parameters acquired from the image correction apparatus 200 via the parameter input unit 304.

In S54, similarly to S15 in FIG. 4, the control unit 305 sets the knee point as the signal level threshold value in the signal level determination unit 307. The knee point used herein is included in the knee correction parameters acquired from the image correction apparatus 200 via the parameter input unit 304.

In S55, similarly to S17 in FIG. 4, the control unit 305 initializes the conversion table which is to be set in the warning image generation unit 308.

Operation and Effect of Embodiment 2

As described above, even in the case where the knee correction is used in the external image correction apparatus 200, the image conversion apparatus 300 of Embodiment 2 can change the warning image displayed in the corrected area of the knee correction in the image data to a difference warning image according to the correction strength of the knee correction. For example, in the case where the image correction apparatus is a camera and the image conversion apparatus is a display, the user can determine the state of the knee correction used in the camera with the external display with high accuracy.

Although the present invention has been described in detail based on its preferred embodiments, the present invention is not limited to the specific embodiments, and various forms within the scope that does not depart from the gist of the invention are also included in the present invention. Further, each embodiment described above is only illustrative of an exemplary embodiment of the present invention, and the embodiments may be appropriately combined with each other.

Note that individual functional units in Embodiments 1 and 2 may or may not be individual pieces of hardware. Functions of two or more functional units may be implemented by common hardware. Each of a plurality of functions of one functional unit may be implemented by each of individual pieces of hardware. Two or more functions of one functional unit may be implemented by common hardware. In addition, each functional unit may or may not be implemented by hardware such as an ASIC, an FPGA, or a DSP. For example, an apparatus may have a processor and a memory in which a control program is stored. Further, the processor reads the control program from the memory and executes the control program, and functions of at least part of functional units of the apparatus may be thereby implemented.

According to the present invention, it becomes possible to easily determine the corrected area and the correction strength of the knee correction.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-040803, filed on Mar. 10, 2020, which is hereby incorporated by reference herein in its entirety.

What is claimed is:

1. An image conversion apparatus comprising at least one memory and at least one processor which function as:
an image input unit configured to acquire image data;
a correction unit configured to correct the image data by compressing a gradation exceeding a first threshold value with a predetermined correction strength; and
a combining unit configured to combine a warning image which differs according to the predetermined correction strength with an area having a gradation exceeding a second threshold value in the image data.

2. The image conversion apparatus according to claim 1, wherein the at least one memory and the at least one processor further function as:
a setting unit configured to allow a user to set setting values for determining the first threshold value, the second threshold value, and the predetermined correction strength.

3. The image conversion apparatus according to claim 1, wherein
the correction unit generates a lookup table defined for each set of RGB values of the image data based on the first threshold value, and corrects the image data based on the lookup table.

4. The image conversion apparatus according to claim 1, wherein
the combining unit combines the warning image having a display color determined based on a conversion table which converts a gradation of the image data to the display color with an area having a gradation exceeding the second threshold value.

5. The image conversion apparatus according to claim 1, wherein
the warning image is a zebra pattern, and
the combining unit combines the warning image having at least any of an interval, a thickness, and a slope of a stripe of the zebra pattern, differing according to the predetermined correction strength with an area having gradation exceeding the second threshold value.

6. The image conversion apparatus according to claim 1, wherein
the second threshold value is equal to the first threshold value, or is a value set by a user.

7. The image conversion apparatus according to claim 1, wherein the at least one memory and the at least one processor further function as:
a display unit configured to display the image data with which the warning image is combined.

8. An image conversion apparatus comprising at least one memory and at least one processor which function as:
an image input unit configured to acquire image data in which a gradation exceeding a first threshold value is compressed with a predetermined correction strength;
a combining unit configured to combine a warning image which differs according to the predetermined correction strength with an area having a gradation exceeding a second threshold value in the image data; and
an acquisition unit configured to acquire setting values for determining the first threshold value, the second threshold value, and the predetermined correction strength.

9. A control method for an image conversion apparatus comprising:
an image input step of acquiring image data;
a correction step of correcting the image data by compressing a gradation exceeding a first threshold value with a predetermined correction strength; and
a combining step of combining a warning image which differs according to the predetermined correction strength with an area having a gradation exceeding a second threshold value in the image data.

10. A non-transitory computer readable storage medium that stores a program, wherein the program causes a computer to execute:
an image input step of acquiring image data;
a correction step of correcting the image data by compressing a gradation exceeding a first threshold value with a predetermined correction strength; and
a combining step of combining a warning image which differs according to the predetermined correction strength with an area having a gradation exceeding a second threshold value in the image data.
